(19) United States
(12) Patent Application Publication
(10) Pub. No.: US 2024/0325949 A1
(43) Pub. Date: Oct. 3, 2024

(54) CUTTING FLUID CIRCULATION DEVICE

(71) Applicant: OKUMA CORPORATION, Niwa-Gun (JP)

(72) Inventors: Yukio GOTO, Niwa-Gun (JP); Satoshi AOYAMA, Niwa-Gun (JP); Kenta ONOSHIMA, Niwa-Gun (JP)

(73) Assignee: OKUMA CORPORATION, Niwa-Gun (JP)

(21) Appl. No.: 18/602,142

(22) Filed: Mar. 12, 2024

(30) Foreign Application Priority Data
Apr. 3, 2023 (JP) 2023-060369

(51) Int. Cl. B01D 36/02; B01D 21/26; B01D 29/11; B01D 33/06; B01D 33/50; B01D 36/04; B23Q 11/10

(52) U.S. Cl. CPC B01D 36/02; B01D 21/267; B01D 29/11; B01D 33/06; B01D 33/50; B01D 36/045; B23Q 11/1069; B01D 2201/084

(57) ABSTRACT

A cutting fluid circulation device includes a first tank reservoir, a primary filter, and a first pump. The tank reservoir stores cutting fluid discharged from a machine tool. The primary filter is provided in the first tank reservoir and filters the cutting fluid. The first pump pumps up the cutting fluid filtered by the primary filter in the first tank reservoir. The first tank reservoir is partitioned into a filtration tank in which the primary filter is disposed, a pumping-up tank in which the first pump is disposed, and a connecting channel in which the cutting fluid in the filtration tank is allowed to flow into the pumping-up tank. The connecting channel has an identical channel width along an entire length thereof, or at least a portion of the channel width is narrowed stepwise or continuously from the filtration tank to the pumping-up tank.

### CROSS REFERENCE TO RELATED APPLICATION

This application claims the benefit of Japanese Patent Application Number 2023-060369 filed on Apr. 3, 2023, the entirety of which is incorporated by reference.

### FIELD OF THE INVENTION

The disclosure relates to a cutting fluid circulation device that stores and filters cutting fluid discharged from a machine tool and resupply the cutting fluid to the machine tool. Note that cutting fluid is also referred to as coolant, and a cutting fluid circulation device is also referred to as a sludgeless tank.

### BACKGROUND OF THE INVENTION

There has been known a cutting fluid circulation device as a device attached to a machine tool. The cutting fluid circulation device separates sludge, which is impurities such as chips, from cutting fluid supplied to a work chamber of the machine tool and discharged from the machine tool and supplies the cutting fluid after filtration again to the machine tool for reuse.

The cutting fluid circulation device requires cleaning and maintenance by human hands. When the cleaning and maintenance are neglected, the cleaning effect in the work chamber cannot sufficiently be obtained, leading to breakage of the machine in the worst-case scenario.

Therefore, as an example of a cutting fluid circulation device, JP 6196409 B discloses a coolant supply device in which coolant discharged from a machine tool is filtered with a drum filter and then returned to a return reservoir. The return reservoir includes first and second coolant reservoirs arranged in parallel with a predetermined space therebetween and a communicating part that allows both coolant reservoirs to communicate with one another. The return reservoir returns the coolant pumped up by a pump disposed in the second coolant reservoir to the first coolant reservoir and assists a flow of the coolant by an agitating nozzle body disposed in each coolant reservoir to suppress deposition and retention of foreign substances.

In addition, JP 2019-155580 A discloses an invention of a cleaning mechanism. The cleaning mechanism pumps up a cleaning liquid in a first tank with a pump, filters it through two first and second filters, supplies the filtered high-precision cleaning solution to a work chamber, switches a flow path to store it in a storage tank, and return it to the first tank. The first tank is disposed adjacent to the second tank. A flow path is provided between the first filter and the second filter to supply the cleaning liquid filtered by the second filter at an upstream side to the second tank. The cleaning liquid in the second tank can be pumped up to supply it to the work chamber with a pump.

The coolant supply device of JP 6196409 B includes one return reservoir, but the return reservoir has a recessed shape in plan view. Thus, the agitating nozzle body is essential to suppress the flow from stagnating. In addition, respective five pumps are provided and used for cleaning the drum filter, for filtering in another filter device, for forming the flow in the return reservoir, and the like, which leads to cost increase.

The cleaning mechanism of JP 2019-155580 A filters the cleaning liquid pumped up from the first tank by only the second filter and supplies it to the second tank. Thus, when the second filter fails and the filter function deteriorates, cleaning fluid containing chips will flow into the second tank. Thus, deposition and retention of the chips in the second tank occur and also causes failure of the second pump.

Therefore, it is an object of the disclosure to provide a cutting fluid circulation device that can effectively suppress deposition and retention of foreign substances with a simple configuration.

### SUMMARY OF THE INVENTION

In order to achieve the above-described object, a first configuration of the disclosure is a cutting fluid circulation device. The cutting fluid circulation device includes a first tank reservoir, a primary filter, and a first pump. The tank reservoir stores cutting fluid discharged from a machine tool. The primary filter is provided in the first tank reservoir and filters the cutting fluid. The first pump pumps up the cutting fluid filtered by the primary filter in the first tank reservoir. The first tank reservoir is partitioned into a filtration tank in which the primary filter is disposed, a pumping-up tank in which the first pump is disposed, and a connecting channel in which the cutting fluid in the filtration tank is allowed to flow into the pumping-up tank. The connecting channel has an identical channel width along an entire length thereof, or at least a portion of the channel width is narrowed stepwise or continuously from the filtration tank to the pumping-up tank.

In another aspect of the first configuration of the disclosure, which is in the first configuration, the cutting fluid circulation device includes a secondary filter, a first circulation flow channel, a tertiary filter, a second tank reservoir, a second pump, and a second circulation flow channel. The secondary filter filters the cutting fluid pumped up by the first pump. The first circulation flow channel returns a portion of the cutting fluid filtered by the secondary filter to the first tank reservoir. The tertiary filter filters a remaining portion of the cutting fluid filtered by the secondary filter. The second tank reservoir stores the cutting fluid filtered by the tertiary filter. The second pump pumps up the cutting fluid in the second tank reservoir. The second circulation flow channel returns the cutting fluid in the second tank reservoir to the first tank reservoir when an amount of the cutting fluid in the second tank reservoir exceeds a predetermined amount regardless of operating or non-operating of the second pump.

In order to achieve the above-described object, a second configuration of this disclosure is a cutting fluid circulation device. The cutting fluid circulation device includes first tank reservoir, a primary filter, a first pump, a secondary filter, a first circulation flow channel, a tertiary filter, a second tank reservoir, a second pump, and a second circulation flow channel. The first tank reservoir stores cutting fluid discharged from a machine tool. The primary filter is provided in the first tank reservoir and filters the cutting fluid. The first pump pumps up the cutting fluid filtered by the primary filter in the first tank reservoir. The secondary filter filters the cutting fluid pumped up by the first pump. The first circulation flow channel returns a portion of the cutting fluid filtered by the secondary filter to the first tank reservoir. The tertiary filter filters a remaining portion of the cutting fluid filtered by the secondary filter. The second tank reservoir stores the cutting fluid filtered by the tertiary filter. The second pump pumps up the cutting fluid in the second tank reservoir. The second circulation flow channel returns the cutting fluid in the second tank reservoir to the first tank reservoir when an amount of the cutting fluid in the second tank reservoir exceeds a predetermined amount regardless of operating or non-operating of the second pump.

In another aspect of the second configuration of the disclosure, which is in the above-described configurations, the cutting fluid circulation device further includes a switching unit that returns a portion of the cutting fluid filtered by the secondary filter to the first tank reservoir via the first circulation flow channel when the second pump is not in operation, and supplies a portion of the cutting fluid filtered by the secondary filter to the tertiary filter when the second pump is in operation.

In another aspect of the second configuration of the disclosure, which is in the above-described configurations, the cutting fluid circulation device the cutting fluid pumped up by the second pump is supplied to a spindle of the machine tool.

The cutting fluid circulation device of the present disclosure allows effectively suppressing deposition and retention of foreign substances with a simple configuration.

### BRIEF DESCRIPTION OF THE DRAWINGS

FIG. 1 is a schematic diagram of a cutting fluid circulation device.

FIG. 2 is a plan view of a first tank reservoir and a second tank reservoir.

FIG. 3 is a plan view of a first tank reservoir and a second tank reservoir in a modification.

FIG. 4 is a plan view of a first tank reservoir and a second tank reservoir in a modification.

### DETAILED DESCRIPTION OF THE INVENTION

The following describes embodiments of the disclosure based on the drawings.

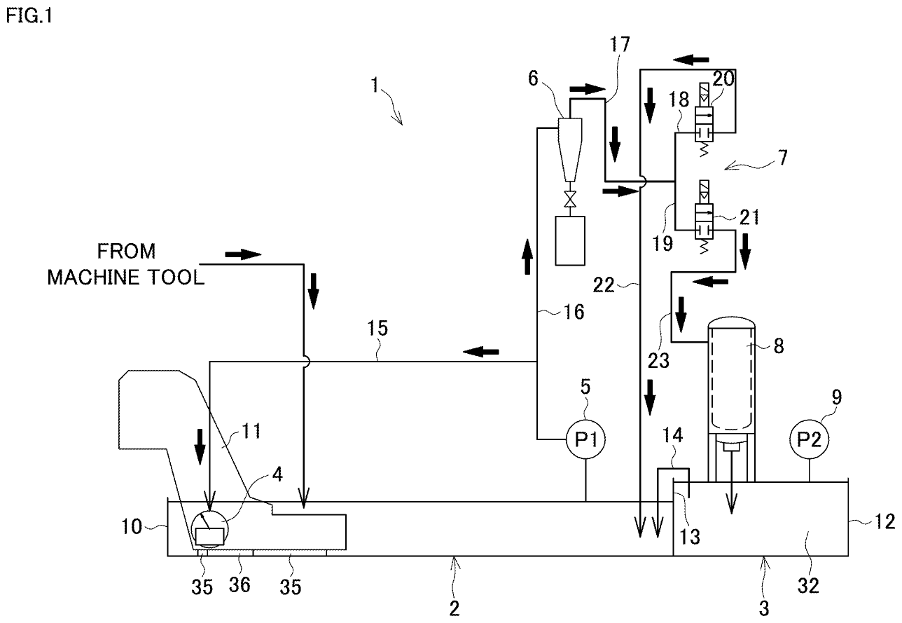

FIG. 1 is a schematic diagram of a cutting fluid circulation device. A cutting fluid circulation device 1 includes a first tank reservoir 2, a second tank reservoir 3, a drum filter 4, a first pump 5, a secondary filter 6, a pipe switching unit 7, a tertiary filter 8, and a second pump 9.

The first tank reservoir 2 is a bottomed reservoir surrounded by a first outer wall 10. Inside the first tank reservoir 2, a conveyor 11 is disposed. Cutting fluid, which contains sludge including chips and the like, is discharged into the conveyor 11 after being used by a machine tool, which is not illustrated.

The second tank reservoir 3 is installed adjacent to the first tank reservoir 2 and is a bottomed reservoir surrounded by a second outer wall 12. However, the second tank reservoir 3 has an area smaller than an area of the first tank reservoir 2 in plan view. The second outer wall 12 of the second tank reservoir 3 is formed higher than the first outer wall 10 of the first tank reservoir 2. On an upper side of a partition plate 13 that divides between the first tank reservoir 2 and the second tank reservoir 3, a circulation flow channel 14 is formed to return the cutting fluid that overflowed in the second tank reservoir 3 to the first tank reservoir 2. The circulation flow channel 14 is an example of a second circulation flow channel of the present disclosure.

The drum filter 4 is installed at a lower portion in the conveyor 11. The drum filter 4 filters the cutting fluid at a filter portion of an outer peripheral surface thereof to remove sludge of a predetermined size or larger. After the filtration, the cutting fluid is discharged into the first tank reservoir 2 from both ends of the drum filter 4 in an axial direction. The drum filter 4 is an example of a primary filter of the present disclosure.

The first pump 5 is disposed in the first tank reservoir 2 and is connected to a cleaning nozzle, which is not illustrated, in the drum filter 4 via a first pipe 15. Thus, the cutting fluid pumped up by the first pump 5 is discharged to the outer peripheral surface of the drum filter 4 from the cleaning nozzle inside to clean the drum filter 4.

The first pipe 15 includes a second pipe 16 that branches off in the middle. The second pipe 16 is connected to the secondary filter 6.

The secondary filter 6 is a cyclone filter installed outside the first tank reservoir 2 and the second tank reservoir 3. The secondary filter 6 is connected to the pipe switching unit 7 via a third pipe 17. The cutting fluid from which sludge has been removed by the secondary filter 6 is sent to the pipe switching unit 7.

The pipe switching unit 7 includes a first branch pipe 18 and a second branch pipe 19 branched in two directions from the third pipe 17, a first valve 20 provided in the first branch pipe 18, and a second valve 21 provided in the second branch pipe 19. The first valve 20 and the second valve 21 perform Switching operation based on commands from a NC device of the machine tool. The first branch pipe 18 is connected to the first tank reservoir 2 via a fourth pipe 22. The second branch pipe 19 is connected to the tertiary filter 8 via a fifth pipe 23. The third pipe 17, the first branch pipe 18, and the fourth pipe 22 are an example of the first circulation flow channel of the present disclosure. The pipe switching unit 7 is an example of a switching unit of the present disclosure.

The tertiary filter 8 is a bag filter installed outside the first tank reservoir 2 and the second tank reservoirs 3. The cutting fluid filtered by the tertiary filter 8 is sent into the second tank reservoir 3.

The second pump 9 is installed inside the second tank reservoir 3. The second pump 9 supplies the cutting fluid in the second tank reservoir 3 to a spindle of the machine tool.

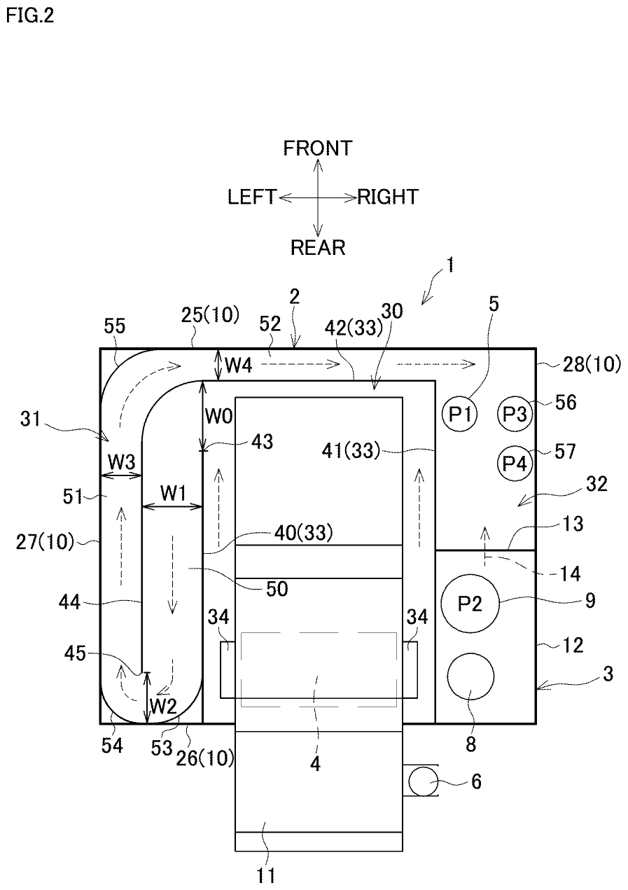

FIG. 2 illustrates a plan view of the first tank reservoir 2 and the second tank reservoirs 3. Piping is omitted. In FIG. 2, the front-rear and left-right orientations are defined with the upper side being the front for convenience. The cutting fluid circulation device 1, which is rectangular in plan view, has a right-left direction as the longitudinal direction. The first tank reservoir 2 is surrounded by a front outer wall 25, a rear outer wall 26, a left outer wall 27, and a right outer wall 28 that form the first outer wall 10 and occupies most of the cutting fluid circulation device 1 except for a rear right side corner portion. The second tank reservoir 3 is provided in the rear right side corner portion of the cutting fluid circulation device 1 and is surrounded by the second outer wall 12. The first tank reservoir 2 includes the partition plate 13 between a pumping-up tank 32, which is described later, and the second tank reservoir 3, and the circulation flow channel 14 formed here returns the cutting fluid that has overflowed in the second tank reservoir 3 to the pumping-up tank 32.

The first tank reservoir 2 includes a filtration tank 30, a connecting channel 31, and the pumping-up tank 32.

The filtration tank 30 is formed approximately in the center of the cutting fluid circulation device 1 and is partitioned by an inner wall 33. The conveyor 11 is disposed in a front-rear direction in the filtration tank 30. The drum filter 4 is disposed at a rear of the conveyor 11 and includes outlets 34, 34 on the right and left sides for the filtered cutting fluid. The conveyor 11 is supported above the bottom of the filtration tank 30 by a support stand 35, as illustrated in FIG. 1. Therefore, a gap 36 is formed between the conveyor 11 and the bottom of the filtration tank 30 through which the cutting fluid passes.

The inner wall 33, which is rectangular in plan view, has a left inner wall 40, a right inner wall 41, and a front inner wall 42. The left inner wall 40 and the right inner wall 41 extend in the front-rear direction, the rear end is connected to the rear outer wall 26, and the front end is positioned behind the front outer wall 25. The front inner wall 42 extends parallel in the right-left direction behind the front outer wall 25, and a right end of the front inner wall 42 is connected to the right inner wall 41. A front end of the left inner wall 40 is not connected to the front inner wall 42, and forms a first communication channel 43 that communicates with inside and outside of the inner wall 33 between the front inner wall 42 and the front end of the left inner wall 40.

The connecting channel 31 extends across the left side and front side of the filtration tank 30 and is formed to be surrounded by the front outer wall 25, the left outer wall 27, the rear outer wall 26, the left inner wall 40, and the front inner wall 42.

In the connecting channel 31, there is a straightening vane 44 that is connected to the front inner wall 42 in an extended manner, bent rearward in an arcuate in plan view, and then extended rearward parallel to the left inner wall 40. A rear end of the straightening vane 44 is positioned in front of the rear outer wall 26, forming a second communication channel 45 between the rear outer wall 26 and the rear end of the straightening vane 44.

Thus, in the connecting channel 31, a first channel 50 is formed to extend in the front-rear direction between the left inner wall 40 and the straightening vane 44 and communicates with the first communication channel 43 and the second communication channel 45. In addition, in the connecting channel 31, a second channel 51 is formed to extend in the front-rear direction between the straightening vane 44 and the left outer wall 27 and communicates with the second communication channel 45. Furthermore, in the connecting channel 31, a third channel 52 is formed to extend in the right-left direction between the front inner wall 42 with the straightening vane 44 and the front outer wall 25 and communicates with the second channel 51.

Here, a channel width W0 of the first communication channel 43, a channel width W1 of the first channel 50, a channel width W2 of the second communication channel 45, a channel width W3 of the second channel 51, and a channel width W4 of the third channel 52 have the following relationship, in which a channel width of a downstream side is stepwise narrower than a channel width of an upstream side channel width.

$$\\ W 0 > W 1 > W 2 > W 3 > W 4$$

At a rear end of the first channel 50, in a corner portion formed by the rear outer wall 26 and the left inner wall 40, a first guiding plate 53, which is arcuate in plan view, is provided and continuously decreases the channel width W1 of the first channel 50 toward the channel width W2 of the second communication channel 45. Similarly, at a rear end of the second channel 51, in a corner portion formed by the rear outer wall 26 and the left outer wall 27, a second guiding plate 54, which is arcuate in plan view, is provided and continuously decreases the width W2 of the second communication channel 45 toward the width W3 of the second channel 51. Similarly, in a corner portion formed by the front outer wall 25 and the left outer wall 27 at a front end of the second channel 51, a third guiding plate 55, which is arcuate in plan view, is provided and continuously decreases the channel width W3 of the second channel 51 toward the channel width W4 of the third channel.

The pumping-up tank 32 is disposed in a front right side corner portion of the cutting fluid circulation device 1. The pumping-up tank 32 is surrounded by the front outer wall 25, the right outer wall 28, the partition plate 13, and the right inner wall 41, and communicates with the third channel 52 of the connecting channel 31. The cutting fluid that has overflowed in the second tank reservoir 3 flows over the partition plate 13 into the pumping-up tank 32.

In the pumping-up tank 32, the first pump 5, a third pump 56, and a fourth pump 57 are disposed. The third pump 56 and the fourth pump 57 pump up the cutting fluid in the pumping-up tank 32 and supply it to the work chamber of the machine tool via pipes, which are not illustrated.

In the cutting fluid circulation device 1 configured as described above, the cutting fluid collected by the conveyor 11 from the machine tool passes through the drum filter 4 to be filtered, and is then discharged into the filtration tank 30 from the right and left sides.

When the first pump 5 operates, the cutting fluid in the pumping-up tank 32 is pumped up and branched into to be supplied to the first pipe 15 and the second pipe 16.

The cutting fluid flowing through the first pipe 15 is discharged from the cleaning nozzles inside the drum filter 4 to clean the drum filter 4, and then returns to the filtration tank 30.

The cutting fluid flowing through the second pipe 16 is filtered by the secondary filter 6 and sent to the third pipe 17. When the cutting fluid is not discharged from a tool mounted on the spindle in the machine tool, the first valve 20 is turned ON, that is open and the second valve 21 is turned OFF, that is closed in the pipe switching unit 7 in accordance with the command from the NC device. Therefore, the cutting fluid supplied from the third pipe 17 returns to the filtration tank 30 through the first branch pipe 18 and via the fourth pipe 22.

Thus, with the first pump 5 running, the cutting fluid is sent to each of the drum filter 4 and the secondary filter 6, and the cleaning of the drum filter 4 and the filtration by the secondary filter 6 are performed at the same time.

In the first tank reservoir 2, the cutting fluid in the filtration tank 30 enters the first channel 50 from the first communication channel 43, flows rearward in the first channel 50, and enters the second channel 51 from the second communication channel 45. The cutting fluid then flows forward in the second channel 51 and enters the third channel 52, and the cutting fluid flows toward the right side in the third channel 52 and enters the pumping-up tank 32.

In this way, the cutting fluid flows in one direction in the connecting channel 31, here, a flow velocity of the cutting fluid increases as the cutting fluid moves downstream because each of the channel widths W0 to W4 in the connecting channel 31 becomes narrower stepwise. Therefore, retention and accumulation of sludge in the connecting channel 31 are less likely to occur, and the sludge flows efficiently into the pumping-up tank 32 and is pumped up by the first pump 5.

When the machining is performed in the machine tool, the third and fourth pumps 56, 57 operate to pump up the cutting fluid in the pumping-up tank 32 and supply it to the work chamber. At this time, when the cutting fluid is discharged from the tool mounted on the spindle in the machine tool, the first valve 20 is turned OFF, that is closed and the second valve 21 is turned ON, that is open in the pipe switching unit 7 in accordance with the command from the NC device. Therefore, the cutting fluid supplied from the third pipe 17 is sent through the second branch pipe 19 to the tertiary filter 8 via the fifth pipe 23. The cutting fluid further filtered by the tertiary filter 8 is discharged into the second tank reservoir 3, pumped-up by the second pump 9, and sent to the spindle.

Even when the secondary filter 6 fails, the tertiary filter 8 provided on the downstream side of the channel to the second tank reservoir 3 suppresses the cutting fluid containing chips from flowing into the second tank reservoir 3.

Thus, the cutting fluid circulation device 1 according to a first configuration includes: the first tank reservoir 2 that stores the cutting fluid discharged from the machine tool; the drum filter 4 provided in the first tank reservoir 2 and filters the cutting fluid; and the first pump 5 that pumps up the cutting fluid filtered by the drum filter 4 in the first tank reservoir 2. The first tank reservoir 2 has an inside formed to be partitioned into the filtration tank 30 in which the drum filter 4 is disposed, the pumping-up tank 32 in which the first pump 5 is disposed, and the connecting channel 31 in which the cutting fluid in the filtration tank 30 is allowed to flow into the pumping-up tank 32.

The connecting channel 31 is formed such that each of the channel width W0 to W4 becomes narrower stepwise from the filtration tank 30 to the pumping-up tank 32.

With the configuration, the flow of the cutting fluid from the filtration tank 30 to the pumping-up tank 32 can be maintained without providing an auxiliary nozzle or the like, and the flow velocity can be increased in the connecting channel 31. Therefore, the deposition and retention of foreign substances can be effectively suppressed with a simple configuration.

In particular, the cutting fluid circulation device 1 further includes: the secondary filter 6 that filters the cutting fluid pumped up by the first pump 5; the third pipe 17, the first branch pipe 18, and the fourth pipe 22 that return a portion of the cutting fluid filtered by the secondary filter 6 to the first tank reservoir 2; the tertiary filter 8 that filters a remaining portion of the cutting fluid filtered by the secondary filter 6; the second tank reservoir 3 that stores the cutting fluid filtered by the tertiary filter 8; the second pump 9 that pumps up the cutting fluid in the second tank reservoir 3; and the circulation flow channel 14 that returns the cutting fluid in the second tank reservoir 3 to the first tank reservoir 2 when an amount of the cutting fluid in the second tank reservoir 3 exceeds a predetermined amount regardless of operating or non-operating of the second pump 9.

Therefore, even when the second pump 9 operates to supply the cutting fluid in the second tank reservoir 3 to the spindle, the flow of the cutting fluid in the first tank reservoir 2 can be maintained as long as the first pump 5 operates. As a result, the deposition and retention of foreign substances in the second tank reservoir 3 can also be effectively suppressed.

The following modifications are possible in the disclosure according to the first configuration.

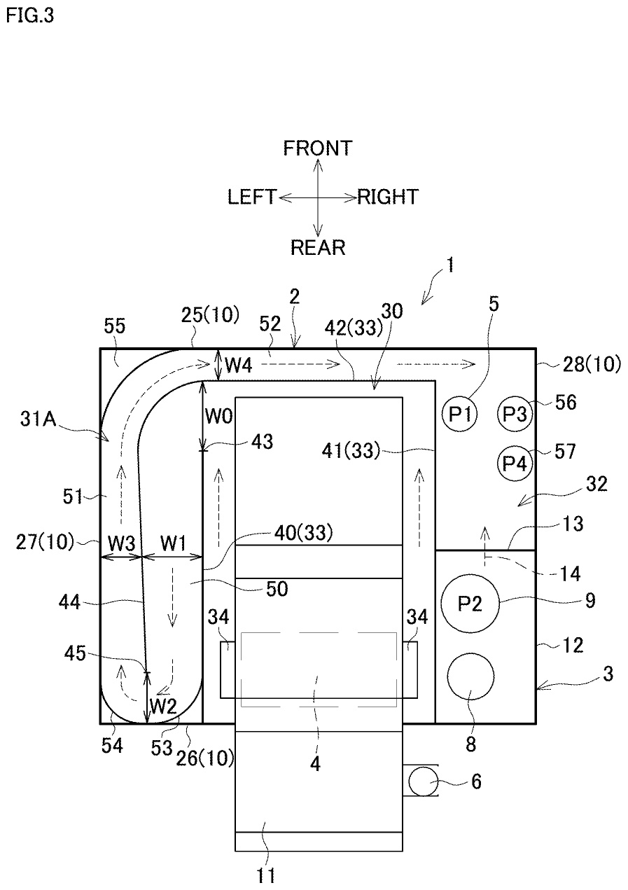

In the above configuration, each channel has a structure in which the channel width narrows stepwise, but it may be a connecting channel in which the channel width narrows continuously. FIG. 3 shows an example thereof. In a connecting channel 31A, the straightening vane 44 is inclined such that a rear end thereof is shifted to the right side from the front-rear direction, which makes the channel width W1 of the first channel 50 to be tapered to gradually narrow toward downstream. The inclination of the straightening vane 44 makes the width W3 of the second channel 51 also to be tapered shape that gradually narrows toward downstream. Also in the structure, the flow velocity of the cutting fluid increases toward downstream.

However, the channel width may be formed to be continuously narrowed over the entire length of the connecting channel 31A, including not only the first channel 50 and the second channel 51, but also the third channel 52.

Furthermore, the connecting channel may be configured in combination with the form of the channel width in FIG. 2 and the form of the channel width in FIG. 3, with a portion of the channel width that is stepwise narrowed and a portion of the channel width that is continuously narrowed.

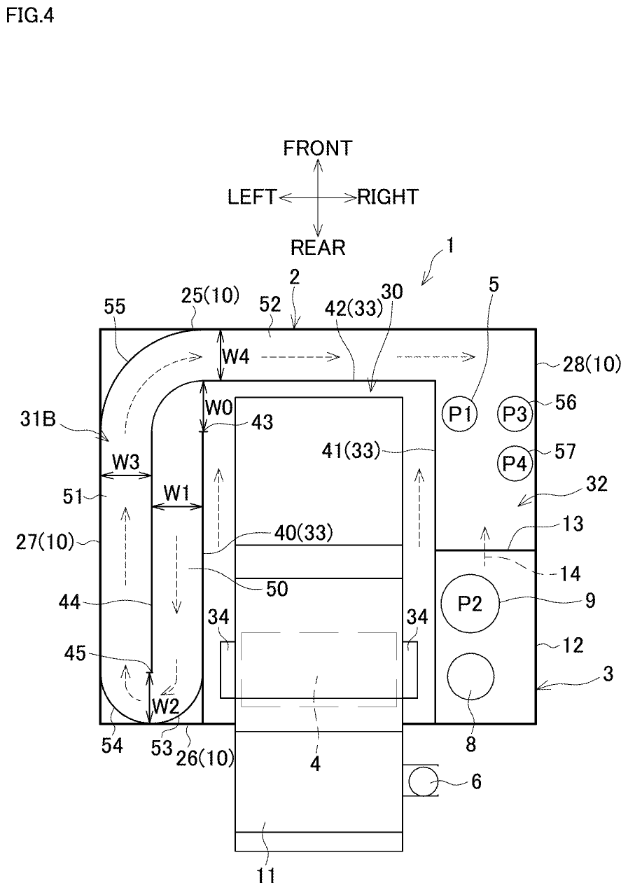

On the other hand, the flow channel width does not have to be varied, but may be formed such that the channel width is the same over the entire length, as illustrated in a connecting channel 31B shown in FIG. 4.

The connecting channel in the above forms and in each of the modifications, the first to third channels are three channels with different flow directions, but the number of channels may be four or more by increasing the number of straightening vane, changing the shape, or by other means. Conversely, the number of the channels may be two or less.

The circuit including the secondary filter, the first circulation flow channel, and the tertiary filter is not limited to the above form, but can be modified as needed. For example, the pipe switching unit and the tertiary filter may be eliminated, and only the first circulation flow channel that returns the cutting fluid filtered by the secondary filter to the first tank reservoir may be provided. In this case, the second tank reservoir and the second circulation flow channel can also be omitted.

The circuit after the secondary filter and the second tank reservoir can be omitted.

Meanwhile, the cutting fluid circulation device 1 according to a second configuration includes: the first tank reservoir 2 that stores cutting fluid discharged from a machine tool; the drum filter 4 provided in the first tank reservoir 2 and filters the cutting fluid; the first pump 5 that pumps up the cutting fluid filtered by the drum filter 4 in the first tank reservoir 2; the secondary filter 6 that filters the cutting fluid pumped up by the first pump 5; the third pipe 17, the first branch pipe 18, and the fourth pipe 22 that return a portion of the cutting fluid filtered by the secondary filter 6 to the first tank reservoir 2; the tertiary filter 8 that filters a remaining portion of the cutting fluid filtered by the secondary filter 6; the second tank reservoir 3 that stores the cutting fluid filtered by the tertiary filter 8; the second pump 9 that pumps up the cutting fluid in the second tank reservoir 3; and the circulation flow channel 14 that returns the cutting fluid in the second tank reservoir 3 to the first tank reservoir 2 when an amount of the cutting fluid in the second tank reservoir 3 exceeds a predetermined amount regardless of operating or non-operating of the second pump 9.

With the configuration, the flow of the cutting fluid in the first tank reservoir 2 can be maintained as long as the first pump 5 operates, even when the second pump 9 operates to supply the cutting fluid in the second tank reservoir 3 to the spindle. In addition, the deposition and retention of foreign substances in the second tank reservoir 3 can be effectively suppressed, the deposition and retention of foreign substances can be effectively suppressed with a simple configuration.

In the disclosure according to the second configuration, the following modifications are possible.

In the above configuration, the second circulation flow channel is a channel through which the cutting fluid exceeding a predetermined amount in the second tank reservoir flows over the partition plate, but it is not limited to the structure. The second circulation flow channel may be formed, for example, by providing one or more perforations in the partition plate or by partially connecting the first tank reservoir and the second tank reservoir with a hose or gutter. When connected by the hose or gutter, the second tank reservoir may be installed separately from the first tank reservoir.

And the following modifications are possible in common with the first and second configurations.

The cutting fluid circulated by the first pump is not limited to the one used to clean the drum filter, but may be filtered by another primary filter and returned to the first tank reservoir.

The cutting fluid pumped up by the second pump may be supplied to a portion other than the spindle. The form of the supply is not limited.

The positions of the third and fourth pumps may be changed as necessary. The number of pumps may be increased, or the pumps may be eliminated.

The plan view shape of the first tank reservoir may also be changed as necessary. The plan view shape may be rectangular with the front-rear direction as the longitudinal direction instead of the right-left direction, or it may be square, polygonal, circular, or the like.

Each filter can have any form other than the above form. The drum filters are not limited to the type built into the conveyor.

The position of the conveyor is not limited to approximately the center of the cutting fluid circulation device as in the above form. The conveyor may be positioned off to either the left or right or either the front or rear of the cutting fluid circulation device. The present disclosure is applicable even to the cutting fluid circulation device in which any conveyor is not disposed.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A cutting fluid circulation device comprising:
a first tank reservoir that stores cutting fluid discharged from a machine tool;
a primary filter provided in the first tank reservoir and filters the cutting fluid; and
a first pump that pumps up the cutting fluid filtered by the primary filter in the first tank reservoir, wherein
the first tank reservoir is partitioned into a filtration tank in which the primary filter is disposed, a pumping-up tank in which the first pump is disposed, and a connecting channel in which the cutting fluid in the filtration tank is allowed to flow into the pumping-up tank, and
the connecting channel has an identical channel width along an entire length thereof, or at least a portion of the channel width is narrowed stepwise or continuously from the filtration tank to the pumping-up tank.

2. The cutting fluid circulation device according to claim 1, further comprising:
a secondary filter that filters the cutting fluid pumped up by the first pump;
a first circulation flow channel that returns a portion of the cutting fluid filtered by the secondary filter to the first tank reservoir;
a tertiary filter that filters a remaining portion of the cutting fluid filtered by the secondary filter;
a second tank reservoir that stores the cutting fluid filtered by the tertiary filter;
a second pump that pumps up the cutting fluid in the second tank reservoir; and
a second circulation flow channel that returns the cutting fluid in the second tank reservoir to the first tank reservoir when an amount of the cutting fluid in the second tank reservoir exceeds a predetermined amount regardless of operating or non-operating of the second pump.

3. The cutting fluid circulation device according to claim 2, comprising
a switching unit that returns a portion of the cutting fluid filtered by the secondary filter to the first tank reservoir via the first circulation flow channel when the second pump is not in operation, and supplies a portion of the cutting fluid filtered by the secondary filter to the tertiary filter when the second pump is in operation.

4. The cutting fluid circulation device according to claim 2, wherein
the cutting fluid pumped up by the second pump is supplied to a spindle of the machine tool.

5. The cutting fluid circulation device comprising:
a first tank reservoir that stores cutting fluid discharged from a machine tool;
a primary filter provided in the first tank reservoir and filters the cutting fluid;
a first pump that pumps up the cutting fluid filtered by the primary filter in the first tank reservoir;
a secondary filter that filters the cutting fluid pumped up by the first pump;
a first circulation flow channel that returns a portion of the cutting fluid filtered by the secondary filter to the first tank reservoir;
a tertiary filter that filters a remaining portion of the cutting fluid filtered by the secondary filter;
a second tank reservoir that stores the cutting fluid filtered by the tertiary filter;
a second pump that pumps up the cutting fluid in the second tank reservoir; and
a second circulation flow channel that returns the cutting fluid in the second tank reservoir to the first tank reservoir when an amount of the cutting fluid in the second tank reservoir exceeds a predetermined amount regardless of operating or non-operating of the second pump.

6. The cutting fluid circulation device according to claim 5, comprising
a switching unit that returns a portion of the cutting fluid filtered by the secondary filter to the first tank reservoir via the first circulation flow channel when the second pump is not in operation, and supplies a portion of the cutting fluid filtered by the secondary filter to the tertiary filter when the second pump is in operation.

7. The cutting fluid circulation device according to claim 5, wherein
the cutting fluid pumped up by the second pump is supplied to a spindle of the machine tool.
